(19) United States
(12) Patent Application Publication
(10) Pub. No.: US 2026/0176436 A1
(43) Pub. Date: Jun. 25, 2026

(54) Stabilized Agglomerated Compositions Made Using Byproducts from Steelmaking Operations

(71) Applicant: S.A. Lhoist Recherche et Developpement, Ottignies-Louvainla-Nueve (BE)

(72) Inventors: Joyce Aderhold, Dormagen (DE); William Edward Johnson, JR., Birmingham, AL (US)

(73) Assignee: S.A. Lhoist Recherche et Developpement, Ottignies-Louvainla-Nueve (BE)

(21) Appl. No.: 18/869,380

(22) PCT Filed: Sep. 26, 2024
(86) PCT No.: PCT/EP2024/077079

§ 371 Date: Nov. 26, 2024

Related U.S. Application Data
(63) Continuation of application No. PCT/IB2023/000582, filed on Sep. 26, 2023.

(51) Int. Cl. C08J 9/14; C22B 1/243

(52) U.S. Cl. CPC C08J 9/146; C22B 1/243

(57) ABSTRACT

An agglomerated composition of reduced iron fine/dust particles, a polymeric binder, a lime based fluxing agent and/or an additional source of carbon, such as biochar charcoal. The agglomerated compositions are able to effectively mimic the melting and chemical characteristics observed with traditional pig iron, DRI, HBI and anthracite additions in the electric arc furnace (EAF). The polymeric binder may be a low melting thermoplastic such as a low or high density polyethylene. The lime based fluxing agent may be a dolime composition.

### BACKGROUND OF THE INVENTION

### 1. Field of the Invention

The present invention relates generally to compositions and methods for binding certain byproducts of iron and/or steelmaking operations, and more specifically, to such agglomerated compositions used as a fuel source which is designed to mimic the melting and chemical characteristics observed with pig iron additions in an electric arc furnace.

### 2. Description of the Prior Art

The basic steelmaking processes involve a well-known series of general steps in the transformation of scrap or hot metal into steel, dependent upon the furnace used. Two main furnaces for use in steelmaking are available, including the electric arc furnace and the basic oxygen furnace (top blown, bottom blown, top and bottom blown). The particular choice of a specific furnace to be used and specific procedure to be followed varies based on criteria known to those skilled in the steelmaking art, depending upon the composition, purity and end-use of the steel desired.

At the present time, there are two major industrial processes using these two main furnace types for producing steel. These may be referred to as integrated steel mills and electric steel mills (mini mills). The integrated steel mill uses the basic oxygen steelmaking process. This process may involve a first step of pelletizing fine iron ore to provide pellets having a certain porosity, a certain mechanical resistance and a shape which allows the flow of hot air in a blast furnace during the melting step. Alternatively, the first step may involve the sintering of iron ore oxides which have been agglomerated in order to have a targeted permeability for the flow of hot air in a blast furnace during the melting step.

In the melting step, coke, lump iron ore, pelletized and/or sintered iron ore and sometimes a fluxing agent are charged into a blast furnace. Combustion of coke with hot air in the blast furnace provides carbon monoxide which reduces the iron oxide into elemental iron with emissions of carbon dioxide. The reduced iron obtained during the smelting process has high carbon content and is also known as “hot metal or pig iron (cast in conveyor-type molds).”

The second major industrial process in the primary metallurgy for producing steel is electric arc furnace (EAF) steelmaking. In an electric arc furnace, scrap is loaded, or direct reduced iron is charged into the furnace, along with supplying electricity, natural gas, carbon-sources and oxygen as energy sources, to produce a batch of steel by electric arc. The EAF produces liquid steel, slag, and EAF baghouse dust (i.e., hazardous waste) in very hot off gas.

Recycled steel scrap makes up the bulk of the metallics addition, but in some cases alternative iron units are also added to dilute any unwanted residuals that are often associated with recycled scrap. Alternative iron units normally come in the form of pig iron, direct reduced iron (DRI), or hot briquetted iron (HBI). All are considered high-purity iron units and each have different performance and usage requirements. They also have different chemical and physical characteristics, thus impacting their appropriateness and cost to the steel customer. The alternative iron units are manufactured by ironmaking facilities, either on the site of the consuming steel mill or off-site by a third-party iron maker. As briefly discussed, pig iron is typically made via the blast furnace and thereafter static-cast or cast in conveyor-type molds. Because the main fuel for pig iron manufacture is coke, the material normally carries a high carbon content, in the range of 4.3% by weight. DRI and HBI are produced in a reduction vessel with natural gas or hydrogen employed as the reducing agent in the western world.

There are various disadvantages associated with the above described steel making technologies as they exist at the present time. First of all, the manufacture of DRI and HBI generates fine iron particles (DRI or HBI fines) that are difficult to use at the steel mills and thus unwanted. Great care has been placed in the beneficiation of the virgin iron ore and high expense has been deployed to reduce the iron oxide to metallic iron at the DRI/HBI manufacturer. Thus, any unwanted production material is essentially considered yield loss and sold for loss, given away, or landfilled.

This negatively impacts the profitability of the DRI/HBI manufacturer. To date, there has been no effective market established for the valorization of these DRI/HBI fines.

Secondly, pig iron, while higher in silica than DRI or HBI and thus creating a need to remove this silica, has the added benefit of high carbon. DRI and HBI typically have a much lower carbon content than pig iron. Carbon provides chemical energy in EAF furnaces, lowering the dependence on electrical energy from the utilities. When balanced properly, the chemical and electrical energy split can be optimized to keep costs down and maximize profitability of the steel mill. Carbon also aids in slag foaming, which is an operational benefit to EAF operators for a variety of reasons. World EAF operators have, over the years become highly reliant on Russia and Ukraine to supply the high-quality pig iron. The recent conflict in Ukraine has impacted the availability of this pig iron supply. EAF operators, particularly those in the US now find themselves low in inventory and thus low in carbon inside their furnaces. Proper electrical/chemical energy splits are harder to achieve today and costs have been rising as a result.

Thirdly, global steelmakers are aggressively seeking to decarbonize the steelmaking process. Traditional integrated ironmaking processes (pig iron, hot metal) are energy-intensive and therefore high CO₂-emitting processes. Finding alternatives, recycling opportunities and waste stream valorization techniques have become paramount issues to all western steelmakers. Similar problems requiring a solution exist in the iron making industries.

The present invention has as its object to provide a solution to many of the above noted problems by providing a stable agglomerated product which can be used as a replacement alternative iron source to such sources as the traditional pig iron, DRI and HBI described above.

### SUMMARY OF THE INVENTION

As will be further described herein, it has been found that the addition of Fluxed Iron Mix (FIM) in the EAF furnace can lead to a replacement of alternative iron and carbon sources, like, but not limited, to pig iron, DRI and HBI and other carbon sources, for example, anthracite and coal in iron and/or steel making operations.

The “Fluxed Iron Mix” (FIM) which is the subject of the present invention aims to address all the disadvantages discussed above. “Fluxed Iron Mix”, as defined herein, is a stable agglomeration of waste product dust/fines produced as a byproduct of steel manufacturing operations, using a polymer as a binder, lime-based products as fluxes and preferably an additional carbon source. Among the dust fines which can be used are DRI/HBI fines. Creating large and durable agglomerates from the DRI/HBI fines means they can be appropriate for standard EAF usage.

A polymeric component is used as the binder and thus, the durability control agent. Durability is crucial as any degradation of the material would again generate the unwanted DRI/HBI fines. The polymer also brings to the EAF a carbon source that has been notably deficient since the shortage of pig iron has been in effect. The additional carbon source can be, for example, a recycled polymer, biocharcoal product or petro coke, anthracite, lignite and/or coal.

The preferred lime-based product used as a fluxing agent is dolime (burnt dolomite). Adding an alternative carbon source, e.g., anthracite or biomass and/or—biocharcoal and dolime or a partially/fully hydrated dolime as a flux, ensures an enrichment of carbon in the melt as well as ensuring that the basicity of the molten slag remains constant and causes no operational disadvantages. In addition, the use of MgO-source in the EAF contributes to efficient steelmaking, better quality control, and enhanced furnace performance, e.g., desulfurization, heat insulation and minimization of wear on the refractory lining. The invention therefore solves the problem of the DRI/HBI manufacturer by providing an outlet for heretofore non-valorized fines/dust iron particles and also solves the problem of carbon deficiency in EAF steel furnaces as the resulting product more aptly mimics the chemistry of pig iron, DRI/HBI.

Thus, simply stated, the compositions of the invention are stable, agglomerated compositions useful as replacement alternative iron and carbon sources to traditional pig iron, DRI, HBI and anthracite in electric arc furnace steel and/or iron making operations, including at least:
fines/dust from steelmaking operations;
a polymeric binder;
dolime/hydrated dolime as a fluxing agent; and
preferably, an additional carbon source.

According to a preferred embodiment of the present invention, the composition comprises from about 50-90% by weight, preferably from about 55-85%, more preferably from about 60-80%, and most preferably from about 65-75% by weight, based upon the total weight of the composition, of fines/dust from steelmaking operations.

According to a preferred embodiment of the present invention, the composition comprises from about 6-15% by weight, preferably from about 7-13%, and most preferably from about 8-12% by weight, based upon the total weight of the composition, of a polymeric binder.

According to a preferred embodiment of the present invention, the composition comprises from about 2-20% by weight, preferably from about 3-18%, more preferably from about 4-16%, even more preferably from about 5-15%, and most preferably from about 6-12% by weight, based upon the total weight of the composition, of dolime/hydrated dolime.

According to a preferred embodiment of the present invention, the composition comprises from about 1-20% by weight, preferably from about 2-19%, more preferably from about 3-18%, even more preferably from about 4-16%, yet even more preferably from about 5-15%, and most preferably from about 6-12% by weight, based upon the total weight of the composition, of an additional carbon source.

In the most preferred case, the fines/dust is comprised of DRI and HBI fines. A particularly preferred class of polymeric binders is a low melting thermoplastic binder with a high melting flow index, for example, low density polyethylene, high density polyethylene and their recycled counterparts. The additional source of carbon might come from a variety of sources, but a preferred source is a biochar charcoal material.

In one particularly preferred embodiment of the invention, the stable, agglomerated compositions useful as replacement alternative iron and carbon sources to traditional pig iron, DRI, HBI and anthracite in electric arc furnace steel and/or iron making operations comprises:
from about 50-90% by weight, based upon the total weight of the composition, of DRI/HBI fines/dust;
from about 6-15% by weight, based upon the total weight of the composition, of a polymeric binder;
from about 2-20% by weight, based upon the total weight of the composition, of dolime; and
from about 1-20% by weight, based upon the total weight of the composition, of an additional carbon source.

A particularly preferred polymeric binder is low density polyethylene and the dolime which is used as the fluxing agent is preferably at least partially hydrated and in some cases may be fully hydrated. The additional carbon source can conveniently be a biochar charcoal, anthracite, lignite and a petro coke material.

The thermoplastic binder binds the other components of the composition together to produce a stable product, for example, a pellet which is useful as an energy source in steel making. The stable, agglomerated composition can further include additional waste byproducts typically accompanying steelmaking operations including, for example, silicon manganese powder, silicon manganese fines, niobium carbide, roasted molybdenum sulfide, iron dust, iron chips, ferroalloy chips, metallic DRI(C) fines, or any combination thereof.

A method is also shown for providing stable volatile materials, such as pellets, as an energy source for steelmaking operations in an EAF process. The preferred method includes the steps of first mixing a volatile material and a thermoplastic binder material to form an agglomerated briquette mixture, wherein the volatile material includes an agglomeration of DRI/HBI fines, an additional carbon source and a lime-based product as a fluxing agent. The pellet mixture is mixed and pre-heated and then extruded at 120-150° C. to form a stabilized agglomerated pellet.

Additional objects, features and advantages will be apparent in the written description which follows.

### BRIEF DESCRIPTION OF THE DRAWINGS

FIG. 1 is a diagram illustrating process data collected during actual trial runs at a steel manufacturing facility, comparing 4 tons of FIM/heat versus a base charge material with no FIM.

FIG. 2 is a diagram, similar to FIG. 1, where average Kwh/ton and Av. Tap O2 are compared for the same trial runs.

### DETAILED DESCRIPTION OF THE INVENTION

The present invention provides a product and process which meet the foregoing described objectives. The invention described herein and the various features and advantageous details thereof are explained more fully with reference to the non-limiting examples which are illustrated in the accompanying drawing and detailed in the following description. Descriptions of well-known components and processes and manufacturing techniques are omitted so as to not unnecessarily obscure the workings of the invention. The examples used herein are intended merely to facilitate an understanding of ways in which the invention herein may be practiced and to further enable those of skill in the art to practice the invention. Accordingly, the examples should not be construed as limiting the scope of the claimed invention.

### EAF Steel Mill Production:

As discussed in the Background section, electric arc furnace (EAF) steel mills place metallics in the furnace for the purpose of melting and the subsequent production of liquid steel. Recycled steel scrap makes up the bulk of the metallics addition, but in some cases alternative iron units are also added to dilute any unwanted residuals that are often associated with recycled scrap. Alternative iron units normally come in the form of pig iron, direct reduced iron (DRI), or hot briquetted iron (HBI). All are considered high-purity iron units and each have different performance and usage requirements. The alternative iron units are manufactured by ironmaking facilities, either on the site of the consuming steel mill or off-site by a third-party iron maker. Pig iron is typically made via the blast furnace and static-cast or conveyor-type molds. DRI and hot briquetted iron (HBI) are produced in a reduction vessel with natural gas or hydrogen typically being employed as the reducing agent. Here, it has been found that the addition of “Fluxed Iron Mix” (FIM) in the EAF furnace can lead to a replacement of alternative iron sources as well as carbon sources, like, but not limited, to pig iron, DRI, HBI, petro coke, anthracite, lignite and/or coal.

As used herein to describe the compositions of the invention, the term “Fluxed Iron Mix” (FIM) means a stable agglomerated composition including at least an agglomeration of dust/fines produced as a byproduct of steelmaking operation, such as a mixture of DRI/HBI fines, a polymeric binder, a lime-based product as a fluxing agent and/or preferably also an additional carbon source.

It may be helpful to also define other terms of art used in the description which follows.

### Definitions

The term “fines/dust”, as used herein, shall mean fines and/or dust.

The term “dolime/hydrated dolime”, as used herein, shall mean dolime and/or hydrated dolime. In particular, this term is understood to mean CaO·MgO, calcium magnesium oxide, also called burnt dolomite or dolomitic lime. It is preferably obtained by calcining dolomitic limestone. As will understood by those skilled in the relevant arts, soft-burned dolomite and hard-burned dolomite differ in terms of their calcining techniques.

Hydrated dolime is a chemical compound formed when dolime (a mixture of calcium oxide (CaO) and magnesium oxide (MgO)) undergoes a hydration process. This process typically occurs under elevated pressure, allowing the magnesium oxide to hydrate. The resulting material is a mixture of calcium hydroxide (Ca(OH)₂) and magnesium hydroxide (Mg(OH)₂). Fully hydrated dolime and semi-hydrated dolime refer to different stages in the hydration process of dolime (a mixture of calcium oxide (CaO) and magnesium oxide (MgO)).

Fully Hydrated Dolime: This is achieved when both the calcium oxide and magnesium oxide in dolime are completely or substantially completely hydrated.

Semi-Hydrated Dolime: This occurs when only a portion of the magnesium oxide is hydrated, while the rest remains in its oxide form.

The term “DRI/HBI”, as used herein, shall mean DRI and/or HBI.

The term “polymer” shall generally include, but is not limited to, homopolymers, copolymers, such as, for example, block, graft, random and alternating copolymers, terpolymers, etc. and blends and modifications thereof. The term can also be taken to include the various possible geometrical configurations of the material, including isotactic, syndiotactic and random symmetries.

The term “low-melting polymer”, as used herein, may generally refer to a polymer having a melt temperature below about 150° C.

The term “biocharcoal”, or Biochar as it is sometimes called, as used in this discussion, is a carbon-enriched biomaterial generated in the combustion of biomass through the process of pyrolysis, but not limited to (hydrothermal carbonization, torrefaction). In pyrolysis, a biomass (e.g., crop and forestry residues, manure, municipal and industrial wastes) is decomposed at temperatures higher than about 400° C., in the complete or near absence of oxygen. It typically has a high-carbon content (approximately 60%-90%).

According to the present invention, the term “pellet” means a compact, for example, weighing about 5 to 100 g per pellet. The pellets may be provided, for example, in the shape of a ball/noodle or pillow form on the order of 8 to 18 mm in diameter, by way of example.

The term “volatile”, as used herein, will be taken to mean any substance or material that is characterized by or prone to sharp or sudden changes or is unstable. For example, pyrophoric materials may be considered volatile because they are liable to ignite spontaneously on exposure to air and/or moisture.

The terms “stable” and “stabilized”, as used herein, may be understood as referring generally to materials that are or have been made to become unlikely to change. For example, volatile materials may be stabilized, at least temporarily. Such stable or stabilized materials containing volatile waste materials may later become volatile yet again when exposed to certain conditions, as will be described herein.

The particular type of “lime” used in the practice of the present invention is of importance and a brief summary of the general types of lime may be helpful to understanding the important differences. The general types of lime available in the marketplace include:
Limestone (calcium carbonate—CaCO₃ with impurities) is present in large quantities in natural rock around the world.
Quicklime (calcium oxide—CaO with impurities) is an alkali and the result of the chemical transformation of limestone by heating it typically above 900° C. Given its rapid reaction with water, calcium oxide, also called burnt lime, is often referred to as quick lime.
Hydrated lime or Slaked lime [calcium (di-)hydroxide—Ca(OH)₂ with impurities] is a strong alkali formed when calcium oxide reacts with water. This reaction generates heat. Depending on the amount of water used, calcium hydroxide can either be a dry hydrate (dry powder), a paste (putty lime) or a liquid milk of lime also called lime slurry (dry suspension in water).
High Calcium Hydrate or hydrated calcium lime or “hical”—hydrated lime containing mainly calcium hydroxide thus containing a low amount of magnesium compound as impurity, i.e. when expressing magnesium as MgO, having less than 5% MgO typically a MgO content lower than 3%, in particular lower than 2% in weight.
Dolomite (double carbonate of calcium and magnesium—CaCO₂·MgCO₂) is the result of a partial or full dolomitization of calcium carbonate.
Dolime or dolomitic lime, as defined above, (calcium & magnesium oxide—CaO·MgO) is the result of the chemical transformation of double carbonate of calcium and magnesium by heating it typically above 900° C.
Hydrated dolime (calcium & magnesium (tetra-)hydroxide—Ca(OH)₂·Mg(OH)₂) represents the completion of the hydration reaction carried out in pressurized reactors at temperatures of around 150° C.

### The Preferred Compositions of the Invention

As will now be more fully described, the “Fluxed Iron Mix” (FIM) compositions of the invention can thus be described an agglomeration of DRI/HBI fines using a polymer as a binder, a dolime component as a fluxing agent and also preferably an additional carbon source.

While the waste dust/fines typically used in the process of the invention are DRI/HBI fines, the Fluxed Iron Mix compositions of the invention can be extended to other fine particle agglomeration efforts as well. Steel mills generate residues/dusts from their alloying materials and other processes throughout the plant. For example, silicon manganese powder, silicon manganese fines, niobium carbide, roasted molybdenum sulfide, iron dust, iron chips, ferroalloy chips, metallic DRI(C) fines, or any combination thereof. On-site agglomeration services could be developed to ensure full use of both virgin and recycled materials. Fluxed Iron Mix thus valorizes certain waste product streams in both DRI/HBI manufacture and plastics recycling and directly avoids CO₂ production via traditional blast furnace pig iron production, serving to further decarbonize the steelmaking process.

The term “dolime” will thus be understood, in view of the above discussion, to mean at least dolime or at least partially hydrated dolime particles or magnesium hydroxide particles or magnesium oxide particles or a combination thereof. By the term “at least partially hydrated dolime” is meant a calcium magnesium compound comprising calcium in majority or totally under the hydrated form Ca(OH)₂ and magnesium under the form MgO and optionally under hydrated form Mg(OH)₂. By the term “fully hydrated dolime” is meant a calcium magnesium compound comprising calcium and magnesium under their hydrated form Ca(OH)₂ and Mg(OH)₂ respectively, the resulting form MgO being marginal.

Based upon the above discussion, the reader will understand that “dolime” is to be distinguished from “lime” or “quicklime.” As has been explained, “quicklime” is the mineral solid material obtained by burning limestone, for which the chemical composition is mainly calcium oxide, CaO. Quicklime is commonly obtained by calcination of limestone, mainly consisting of CaCO₃. Quicklime contains impurities, i.e., compounds such as magnesium oxide, MgO, silica, SiO₂ or further alumina Al₂O₃, etc., in an amount of a few percent.

One method for producing hydrated dolomite is referred to as the “dry route” and is described in the relevant literature. In the large majority of cases, the hydrated dolomite or any other mixed calcium and magnesium hydroxide industrially produced via a dry route is in reality a dolomite semi-hydrate or any other aforementioned mixed hydroxide, containing a non-negligible amount of residual non-hydrated MgO. The aforesaid dolomite semi-hydrate is generally represented by the formula Ca(OH)₂·MgO or Ca(OH)₂·Mg(OH)₂·MgO depending on the hydration level of the magnesium oxide. A dolomite product totally hydrated is known as “Type S.” Adding a dolime or hydrated dolime component (flux), ensures that the basicity of the molten slag remains constant and causes no operational disadvantages. Type S dolimes are defined in ASTM C207. The Type S product is commercially available from Lhoist North America, as well as other sources, and three_certificates of analysis of the commercially available Lhoist Type S product are summarized in Table I below:

TABLE I

| Parameter | | Result | Result | Result | |
|---|---|---|---|---|---|
| (from ASTM C207) | Specification | 05/31 | 06/30 | 08/01 | Average |
| % Free moisture | <3.00 | 1.30 | 1.29 | 1.44 | 1.34 |
| % retained No. 30 | <0.50 | 0.35 | 0.44 | 0.42 | 0.40 |
| sieve (600 μm) | | | | | |
| % retained No. 200 | N/A | 90.28 | 89.85 | 90.31 | 90.15 |
| sieve (75 μm) | | | | | |
| Emley plasticity | >200 | 314 | 279 | 305 | 299.33 |
| Soundness | A1-B7 | A1 | A2 | A2 | A2 |

The Fluxed Iron Mix (FIM) of the invention also includes a polymer binder component. Creating large and durable agglomerates from the DRI/HBI fines means they can be appropriate for standard EAF usage. The polymer is used as a durability control agent. A sufficiently durable product is essential, as any degradation of the material would again generate the unwanted DRI/HBI fines. The polymer also brings to the EAF a carbon source that has been deficient since the shortage of pig iron has been in effect as well as increasing the amount of carbon provided by the DRI and HBI.

One preferred class of polymers is polyethylene. Polyethylene (PE) is a hydrocarbon (in the variety of LDPE or HDPE), and thus increases the carbon content of the extrudate. Where DRI/HBI can have <2.5% carbon, and pig iron has about 4.3% carbon, the carbon content in fluxed pig iron can be manipulated by adding more or less LDPE at the discretion of the customer. The PSD and low-melting temperature of LDPE ensure a minimal amount of heating is required to achieve the optimal plasticization of the product. Upon again cooling to ambient temperatures, the plastics provide superior durability to the entire agglomerate. A certain minimum amount of LDPE is generally required to properly bind the material. The ultimate intention is to replace virgin LDPE (not limited to) with recycled LDPE (not limited to), thus providing an outlet for recycled plastic materials and extending efforts to decarbonize the steelmaking process.

In this regard, there are chemical benefits to having the polymers (i.e., a carbon source) in close contact with iron oxides when reintroduced into a furnace because the release (i.e., burning) of the carbon will pull oxygen molecules off of the iron oxide, thereby leaving the user with iron. In addition, some of the materials contained in the stabilized volatile briquettes may be used as an energy source for the furnace.

Another preferred component of the compositions of the invention is the additional source of carbon. This is preferably a recycle material, such as a biochar charcoal. As defined above, biochar charcoal is a carbon-rich material produced during pyrolysis process that is a thermochemical decomposition of biomass with a temperature of about ≤700° C. in the absence or limited supply of oxygen. It can thus be described as being a rigid amorphous carbon matrix residue that derives from thermal degradation of lignin and hemicellulose after its high mass loss in the form of volatiles. The production percentage of biochar depends on the biomass and pyrolysis condition and ranges between 10 and 35%. Although at low temperatures (450-500° C.) a high quantity of biochar is achieved (due to low devolatilization rates and low carbon conversion), the quantity is reduced to 8-10% of biochar at moderate temperatures (550-650° C.) and yield is even lower at temperatures above 650° C.

Pyrolysis conditions such as reactor type and shape, biomass type, feedstock particle size, chemical activation, heating rate, residence time, etc., affect the physical characteristics of biochar. Higher heating rates (105-500° C./s), shorter residence times, and finer feedstock give finer biochar whereas slow pyrolysis with larger feedstock particle size gives a biochar with coarser particle size. In general, coarser biochar is produced from wood-based biomass while finer biochar is produced from crop residues and manures.

While optimization opportunity still exists, a general range of each of the above described components in the agglomerated products of the invention is 50-90% by weight DRI/HBI fines/dust, 6-15% by weight polymer binder, 1-20% by weight biochar charcoal, and 2-20% by weight dolime and/or hydrated dolime, all based upon the total weight of the agglomerated product. According to a preferred embodiment of the present invention, the agglomerated product of the invention comprises, based upon the total weight of the agglomerated product, 50-90% DRI/HBI of fines/dust.

The agglomerated products of the invention are thus characterized as being comprised of “more iron and less carbon” than the prior art products which were “more carbon and less iron.” By “more iron” is meant more than about 50% by weight iron, based upon the total weight of the agglomerated product, and preferably more than about 75% by weight iron.

According to a further preferred embodiment of the present invention, the agglomerated product of the invention comprises, based upon the total weight of the agglomerated product, 6-15% of polymer binder. According to a further preferred embodiment of the present invention, the agglomerated product of the invention comprises, based upon the total weight of the agglomerated product, 1-20% by weight of biochar charcoal. According to a further preferred embodiment of the present invention, the agglomerated product of the invention comprises, based upon the total weight of the agglomerated product, 2-20% by weight of dolime and/or hydrated dolime. Extrusion, in particular extrusion using this combination, has yielded densities that range from 3.0 g/cm³ to 3.7 g/cm³. This density is considered beyond that required by EAF operators and limits the possibility of the material crushing in transport and handling, and thus again creating fine particles that are difficult to valorize.

### The Manufacturing Process:

Certain embodiments according to the invention provide pellets containing volatile materials that are safe for transport. In particular, embodiments of the invention are directed to stabilized volatile pellets. The thermoplastic binder component binds the volatile material together to define briquettes that are stable (e.g., non-pyrophoric). To date, the most efficient means of agglomeration has proven to be extrusion. Extrusion gives the advantages of high-density and continuous feeding, rather than a batch process. Continuous feeding almost always equates to lower OPEX, therefore creating efficiencies.

Heat is provided via heating elements placed inside the machinery of the extruder. As the combination of materials travels toward the extruder die, the material passes through an electrically heated section and provides enough heat to give a gel-quality to the LDPE. The extrudate may be left alone to cool to room temperature, thus hardening to sufficient durability levels in the process.

In one aspect of the invention, a process is described for providing stable waste DRI and carbon as an energy source for EAF furnaces used in the steelmaking process, although any furnace known in the art to be used in steelmaking and/or burning DRI may be used. This process may include mixing the volatile waste material together with a thermoplastic binder material, a dolime component and/or an additional carbon source, to form a pellet mixture, pre-heating the pellet mixture, extruding the pellet mixture at a temperature of 120-150° C. to form a thermoplastic pellet extrusion and hardening the thermoplastic pellets extrusion to form a stabilized volatile pellet. The pellets so produced may be stockpiled with the iron being isolated and contained therein, and later burned as an energy source for the EAF furnace. In this regard, the thermoplastic binder material binds the volatile waste material together to render the volatile waste material stable and/or non-pyrophoric for transport, but the volatile waste material may be released from the thermoplastic binder material when burned.

It has also been noted, in a chemical analysis of the so formed stabilized volatile pellets, that the final product contains iron carbide (Fe3C). The iron carbide has been found to generally make up more than about 40% by weight, e.g., 47.2% by weight, of the total iron content of the finally formed pellets. The presence of iron carbide is extremely important for the steel industry. A report by the Department of Energy Technology Roadmap Program of United States of America has recognized that iron carbide is the best material for control of the nitrogen in the production of steel with the electric arc furnaces. Iron carbide is a material that is hard, thick and chemically stable.

When the iron carbide enters the electric arc furnace, it dissolves instantly. Then, the uniformly dissolved carbon reacts with the small amount of iron oxide which remains in the iron carbide product. The carbon and iron oxide form carbon monoxide. This generates a large quantity of tiny bubbles of carbon monoxide, which create a boiling of the metal, thereby rapidly homogenizing the molten metal bath, absorbing nitrogen and hydrogen and creating a foamy slag, which in turn allows the removal of the unwanted nitrogen and hydrogen in the steel.

Table II which follows is an exemplary chemical analysis of the final product:

TABLE II

| | |
|---|---|
| Fe Total | 83.8 |
| Fe Metallic | 36.5 |
| Fe from | 47.2 |
| Fe3C | |
| Fe Total | 83.75318 |
| MgO | 2.436069 |
| CaO | 8.374242 |
| Al₂O₃ | 1.116475 |
| SiO₂ | 3.778838 |
| P₂O₅ | 0.104968 |
| SO₃ | 0.027264 |
| K₂O | 0.095425 |
| Ti | 0.068161 |
| Cr | 0.029991 |
| MnO | 0.193577 |
| Sr | 0.014995 |
| Zr | 0.006816 |

There are known apparatuses for extruding the product compositions of the invention. An exemplary apparatus may include, for example, an extruder, a heating portion operably connected to the extruder, and a heated die operably connected to the heating portion. The extruder, the heating portion, and the heated die are configured to gradually heat a thermoplastic binder material such that the thermoplastic binder material binds the volatile materials and other components together. Heat is thus provided via heating elements placed inside the machinery of the extruder. As the combination of described materials travels toward the extruder die, the material passes through an electrically heated section and provides enough heat to give a gel-quality to the LDPE.

### Field Trial Runs:

A 100-ton trial run agglomerated product was prepared using 83% dust and 17% binders, including polymers and lime-based products. The calculated iron and carbon content in the recipe was 72% and 12% by weight, respectively.

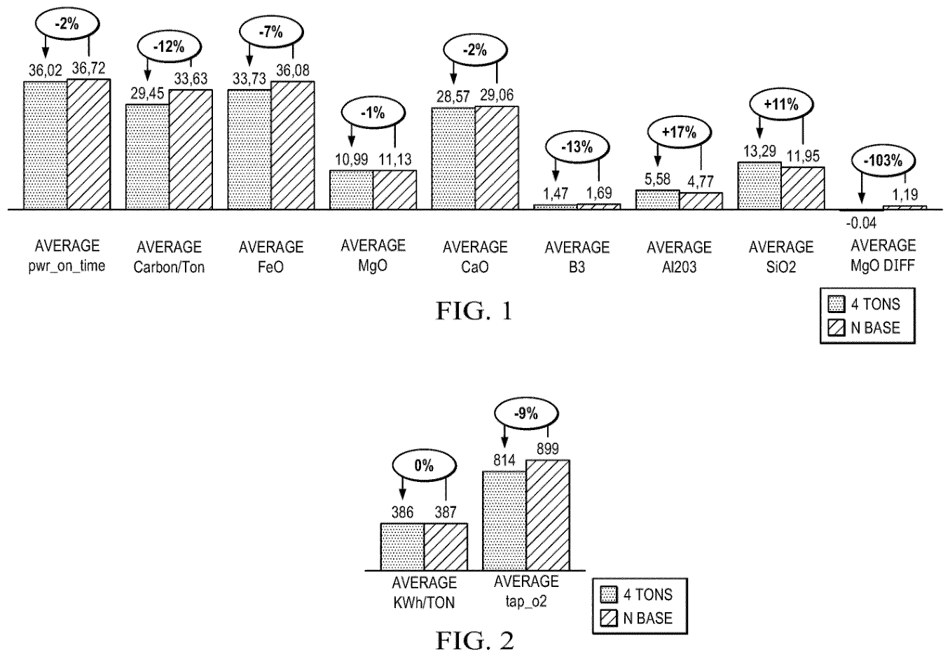

Trial heats were then run at the steel manufacturing facility using 4 tons of FIM per heat, allowing for 11 heats to be carried out. FIG. 1 of the drawings graphically illustrates the data collected during the trial period, comparing the 4 tons of FIM/heat trials versus a base trial run (N Base) with no FIM added.

The data collected showed a decrease in power on time of 2%, resulting in an increase in productivity, along with a 7% improvement in FeO. This corresponds to a 6.5% improvement in injection carbon. The improvement in bucket carbon was measured at 12%.

Silica was seen to increase by 11% during the 4 ton trial, leading to a decrease in B3 of 13%. To address this issue, several adjustments could be made in the process, for example, by adding more fully hydrated dolime or replacing it with dolime in the recipe. These adjustments should adequately compensate for SiO₂, Al₂O₃ and MgO differences.

As can be seen in FIG. 2, there was no significant change in kWh/ton or power on time. The decrease in the tap O2 of 9% can also be observed.

### Advantages of the Invention

An invention has been provided with several advantages. The compositions of the invention are stable, agglomerated compositions useful as a replacement alternative iron and carbon sources to traditional pig iron, DRI, HBI and anthracite in electric arc furnace steel making operations. The compositions can also be used in iron manufacturing processes. The process of the invention produces large and durable agglomerates from DRI/HBI waste fines from steelmaking operations that can meet the appropriate standards for EAF usage. The so-produced agglomerates are sufficiently durable for use in the manner described. Durability is crucial, as any degradation of the material would again generate the unwanted DRI/HBI fines. The polymer component of the compositions also brings to the EAF a carbon source that helps to mitigate the loss of the higher carbon content pig iron. The addition of the biocharcoal and dolime components ensures an enrichment of carbon in the melt as well as ensuring that the basicity of the molten slag remains constant. The invention therefore solves the problem of the DRI/HBI manufacturer by providing an outlet for heretofore non-valorized fines/dust iron particles and also solves the problem of carbon deficiency in EAF steel furnaces as the resulting product more aptly mimics the chemistry of pig iron.

The success criteria for the actual field trial runs, when using the FIM product of the invention, compared to traditional alternative iron units plus charge carbon, were as follows:
Metallurgical targets are not compromised in the process of EAF steelmaking.
No disruption of normal EAF furnace operations noticed.
Chemical energy efficiency is improved.
A more thorough transfer of carbon to the steel bath in the EAF is noticed.
EAF slag chemistry remains consistent and controllable and is as predictable as using traditional alternative iron units plus charge carbon.
Tap-to-tap times, KWh/t consumption (electricity), gas consumption, and/or electrode consumption metrics are improved in the EAF process.
Iron yield is improved.
General process improvement is noted.
A decrease in injection carbon or slag foaming agents is noted.

While the invention has been shown in several of its forms it is not thus limited but is susceptible to various changes and modifications thereof.

1: A stable, agglomerated composition useful as replacement alternative iron and carbon sources to traditional pig iron, DRI, HBI and anthracite in electric are furnace steel making and/or iron manufacturing operations, the composition comprising:
fines/dust from steelmaking operations;
a polymeric binder;
dolime as a fluxing agent; and
wherein the fines/dust is comprised of DRI and HBI.

2: The composition of claim 1, wherein the composition comprises an additional carbon source.

3: The composition of claim 1, wherein the polymeric binder is a low melting thermoplastic binder.

4: The composition of claim 1, wherein the polymeric binder is low density polyethylene.

5: The composition of claim 2, wherein the additional carbon source is a biochar charcoal.

6: A stable, agglomerated composition useful as replacement alternative iron sources to traditional pig iron, DRI, HBI and anthracite in electric are furnace steel making and/or iron manufacturing operations, the composition comprising:
from about 50-90% by weight, based upon the total weight of the composition, of DRI/HBI fines/dust;
from about 6-15% by weight, based upon the total weight of the composition, of a polymeric binder;
from about 1-20% by weight, based upon the total weight of the composition, of biochar charcoal;
from about 2-20% by weight, based upon the total weight of the composition, of dolime.

7: The composition of claim 6, wherein the polymeric binder is low density polyethylene.

8: The composition of claim 6, wherein the dolime is at least partially hydrated.

9: The composition of claim 6, in which the thermoplastic binder binds the other components together to produce a stable pellet which is useful as an energy source in steel making and/or iron manufacturing operations.

10: The composition of claim 1, wherein the stable, agglomerated composition useful as replacement alternative iron and carbon sources to traditional pig iron, DRI and HBI in electric are furnace steel making and/or iron manufacturing operations is a fluxed iron mix composition.

11: The composition of claim 1, wherein the stable, agglomerated composition further includes at least one of silicon manganese powder, silicon manganese fines, niobium carbide, roasted molybdenum sulfide, iron dust, iron chips, ferroalloy chips, metallic DRI(C) fines, or any combination thereof.

12: A method for providing stable volatile materials as an energy source for steelmaking operations in an EAF process, the method comprising the steps of:
mixing a volatile material, a thermoplastic binder material and a dolime product as a fluxing agent and/optionally an additional carbon source, to thereby form an agglomerated pellet mixture,
wherein the volatile material includes an agglomeration of DRI/HBI fines;
pre-heating the pellet mixture;
extruding the pellet mixture to form a thermoplastic pellet extrusion; and allowing the extrusion to harden to thereby form a stabilized volatile pellet.

13: The method of claim 12, further comprising the steps of:
stockpiling the plurality of stabilized volatile pellets;
burning the stabilized volatile pellets during a steelmaking process, wherein burning the stabilized volatile pellets releases the volatile material from the thermoplastic binder material.

14: The method of claim 12, wherein the volatile material further comprises at least one of silicon manganese powder, silicon manganese fines, niobium carbide, roasted molybdenum sulphide, iron dust, iron chips, ferroalloy chips, metallic DRI(C) fines, or any combination thereof.

15: The method of claim 12, wherein the volatile material includes:
from about 50-90% by weight, based upon the total weight of the composition, of DRI/HBI fines/dust;
from about 6-15% by weight, based upon the total weight of the composition, of a polymeric binder;
from about 1-20% by weight, based upon the total weight of the composition, of biocharcoal;
from about 2-20% by weight, based upon the total weight of the composition, of dolime as a fluxing agent.

16: The method of claim 12, wherein the stabilized volatile pellets produced by the process contain iron carbide.

17: The method of claim 16, wherein the stabilized volatile pellets contain greater than about 40% iron carbide when analyzed chemically.
